(19) United States
(12) Patent Application Publication
(10) Pub. No.: US 2026/0341670 A1
(43) Pub. Date: Oct. 29, 2026

(54) PRE-LITHIATED AND CARBON-ENCAPSULATED SILICON-BASED ANODE MATERIAL AND METHOD FOR PREPARING USING PHOTOELECTROMAGNETIC ENERGY

(71) Applicants: VITZROCELL CO. LTD., Dangjin-si, Chungcheongnam-do (KR); MAKESENS INC., Calgary, Alberta (CA)

(72) Inventors: Simon PARK, Calgary, Alberta (CA); Chaneel PARK, Calgary, Alberta (CA); Hongseok CHO, Calgary, Alberta (CA); Jong-Song KIM, Dangjin-si, Chungcheongnam-do (KR); Kyoung-Soo PARK, Dangjin-si, Chungcheongnam-do (KR); Ji-Hoon KANG, Dangjin-si, Chungcheongnam-do (KR); Michaud XAVIER, Calgary, Alberta (CA)

(21) Appl. No.: 19/110,961

(22) PCT Filed: Aug. 23, 2023
(86) PCT No.: PCT/KR2023/012491

§ 371 Date: Mar. 12, 2025

(30) Foreign Application Priority Data
Sep. 16, 2022 (KR) 10-2022-0117215

(51) Int. Cl. H01M 4/04; H01M 4/02; H01M 4/36; H01M 4/38; H01M 4/48; H01M 4/62; H01M 10/052

(52) U.S. Cl. CPC H01M 4/0471; H01M 4/366; H01M 4/386; H01M 4/48; H01M 4/622; H01M 4/625; H01M 10/052; H01M 2004/027

(57) ABSTRACT

A method for preparing an anode material for a lithium secondary battery using pre-lithiation and photoelectromagnetic energy irradiation, and an anode material for a lithium secondary battery as prepared by the method are disclosed. The method includes mixing an active material, a polymer and a lithium salt with each other in a solvent to produce a liquid mixture; converting the liquid mixture into liquid droplets and drying the droplets into powders; and applying photoelectromagnetic energy.

### TECHNICAL FIELD

The present disclosure relates to a method for preparing an anode material for a lithium secondary battery such as a lithium ion battery, a lithium metal battery, a lithium sulfur battery, a lithium air battery, and the like. In particular, the present disclosure relates to a method for preparing an anode material for a lithium secondary battery in which an active material may be pre-lithiated and encapsulated using photoelectromagnetic energy irradiation.

Furthermore, the present disclosure relates to a pre-lithiated and encapsulated anode materials for a lithium secondary battery.

### BACKGROUND ART

Demand for lithium secondary batteries, such as lithium ion batteries, is increasing because of application thereof to a wide range ranging from small and portable electronic products to large electric vehicles. The transition from fossil fuel vehicles to electric vehicles is becoming visible, and accordingly, interest in high-performance lithium secondary batteries is further increasing. A lot of research is underway to achieve higher capacity, longer lifespan, faster charging and improved safety of the lithium secondary batteries. One of them is to develop an electrode using an active material with higher energy density than before.

Silicon (Si) with a theoretical capacity of 3,600 mAh/g is attracting attention as an active material candidate for an anode of the lithium-based battery due to its high energy density. However, silicon is known to have a high volume expansion during repeated lithiation processes. Such rapid volume change causes the active material to be crushed and be peeled off, resulting in loss of electrode integrity and electrical insulation, thereby degrading battery performance.

Several ideas have been proposed to solve the problems related to the volume expansion of the active material. The active material may be encapsulated with a hard outer shell to restrict the volume change of the active material or to provide a sufficient space. Thus, charge/discharge cycles may be applied without physical stress.

In some prior literature, it is proposed to form a nanoporous structure in the active material or in a shell surrounding the active material to increase a reactive surface area to facilitate ion diffusion. However, this technique entails high economic or environmental cost associated with a procedure thereof, consequently increasing a production cost of the battery product.

In addition, in a silicon-based anode material, lithium ions react on a surface of silicon and then are lost into an irreducible state. Thus, the silicon-based anode material has lower initial efficiency than that of a graphite-based anode material. Pre-lithiation has been proposed as a method to solve this problem. However, in pre-lithiation after application and drying of an anode slurry, a complex process is required to prevent reaction with a material such as binder or graphite in the slurry. In addition, this process is divided into a process such as encapsulation of silicon and a subsequent pre-lithiation process. This increases the complexity of the overall process.

### DISCLOSURE OF INVENTION

### Technical Problem

A purpose of the present disclosure is to provide a method for preparing an anode material for a lithium secondary battery which is capable of pre-lithiating and encapsulating an active material.

Furthermore, another purpose of the present disclosure is to provide an anode material for a lithium secondary battery that is pre-lithiated and encapsulated.

### Solution to Problem

A method for preparing an anode material for a lithium secondary battery according to the present disclosure as devised to solve the above problems pre-lithiates and encapsulates an active material for an anode having a large volume expansion such as silicon. In accordance with the present disclosure, the photoelectromagnetic energy application is employed together with droplet drying into powders. The photoelectromagnetic energy that may be used in the method of the present disclosure may be applied in an intense pulsed light (IPL) or microwave form. Each of the IPL and microwave applications simplifies a heat transfer process, and may transfer high energy in a short time at less heat loss than that in a conventional heating scheme.

One aspect of the present disclosure provides a method for preparing an anode material for a lithium secondary battery, the method comprising: mixing an active material, a polymer and a lithium salt with each other in a solvent to produce a liquid mixture; converting the liquid mixture into liquid droplets and drying the droplets into powders; and applying photoelectromagnetic energy to the powders to pre-lithiate the active material and to carbonize at least a portion of the polymer.

Among photoelectromagnetic energy applications, the IPL application is performed by irradiating high-power xenon-light in a wavelength range of 500 to 1200 nm. In this regard, the carbonization effect of the polymer may vary according to the IPL application time. For example, when the IPL application time is within a few milliseconds, the carbonization effect is mainly concentrated on the outer shell, resulting in a shell structure including a hard carbonized outer shell and a soft inner polymeric inner shell. For example, when the IPL application time is equal to or larger than 10 milliseconds, the entirety of the polymer may be carbonized, resulting in a shell entirely made of carbon. The carbonized outer shell or carbonized shell may provide structural support and may provide electrical conductivity along the solid electrolyte interface (SEI). The inner and soft polymeric layer may be elastic to provide an active material space for volume expansion while preventing the active material from being crushed.

In the microwave application, a partially or fully carbonized shell may be formed depending on the applied power or the application time. The microwave refers to a photoelectromagnetic wave in a wavelength band about 1 to 1000 mm, and directly increases the temperature of an object via dipolar polarization or interfacial polarization or transfers heat indirectly surroundings around the object using plasma.

The heat generated in the process of the polymer carbonization via the applying of the IPL or microwave may promotes the reaction between the lithium salt and the silicon, so that silicon may be lithiated.

In one implementation of the method, the active material includes at least one of silicon or silicon oxide.

In one implementation of the method, the active material is pre-surface-treated under the application of the photoelectromagnetic energy. Via the pre-surface treatment, impurities contained in the active material may be burned in a short time, and a stable oxide layer may be formed on the surface of the active material, and the surface energy of the active material may be changed such that wettability thereof to the electrolyte may be increased.

In one implementation of the method, the lithium salt includes at least one of Li₂O, LiOH, LiO₂CH, Li₂CO₃, Li₂C₂O₄, Li₃C₆H₅O₇, LiNO₃, LiCl, LiF or a lithium functionalized polymer.

In one implementation of the method, the solvent includes an aqueous or organic solvent.

In one implementation of the method, converting the liquid mixture into the liquid droplets and drying the droplets into the powders includes: spraying the liquid mixture into an air-suspended chamber to produce the liquid droplets; and drying the liquid droplets into the powders using a heater while the liquid droplets are floated and circulated in the air-suspended chamber.

In one implementation of the method, applying the photoelectromagnetic energy includes applying the photoelectromagnetic energy into the air-suspended chamber for accelerating the drying process or for the carbonization and the pre-lithiation.

In one implementation of the method, converting the liquid mixture into the liquid droplets and drying the droplets into the powders includes: spraying the liquid mixture into a chamber to produce the liquid droplets; rapidly-freezing the liquid droplets in the chamber using nitrogen gas to produce frozen droplets; and vacuum-drying the frozen droplets into the powders.

Another aspect of the present disclosure provides an anode material for a lithium secondary battery, the anode material comprising: a lithiated active material; and a shell layer surrounding the lithiated active material and having pores formed therein, wherein the lithiated active material includes a lithium-silicon alloy and a lithium silicate layer surrounding the lithium-silicon alloy, wherein an outermost portion of the shell layer is made of carbon.

### Advantageous Effects of Invention

In accordance with the present disclosure, a novel method for encapsulating the active material using the pre-lithiation and the photoelectromagnetic energy irradiation is provided. According to the method for preparing the anode material for a lithium secondary battery according to the present disclosure, the pre-lithiation and the encapsulation of the active material may be simultaneously achieved using the photoelectromagnetic energy irradiation.

Furthermore, according to the method for preparing the anode material for a lithium secondary battery according to the present disclosure, an electrically conductive hard protective shell may be provided. Via the pre-lithiation prior to the encapsulation of the active material, the active material may be pre-lithiated in the state of being the powder type anode material before an anode electrode is manufactured.

In particular, in accordance with the present disclosure, the anode active material may be pre-lithiated, such that an effect of increasing ICE (Initial Coulombic Efficiency) may be obtained during battery assembly. This minimizes the amount of the anode material consumed due to irreversible capacity, and thus increases the capacity while reducing an anode amount ratio in the design of the anode electrode to increases the energy density of the battery. The silicon oxide film which may be formed when the silicon is exposed to air changes to the lithium silicate film to prevent the lithiated silicon from causing unnecessary chemical reactions in the anode preparation and battery manufacturing processes. Since the shell made of hard carbon covers the active material so as to be adapted to the volume of the active material that has been lithiated and expanded, the active material may not be broken, which may otherwise occur due to the silicon expansion during the subsequent charging and discharging process. The anode material of the present disclosure is not a mixture of graphite-silicon. Thus, it is not necessary to use a lithiation solution that does not react with graphite in consideration of oxidation of graphite or breakage of carbon chains as in a conventional method, and has a complex preparation process and is expensive.

### BRIEF DESCRIPTION OF DRAWINGS

Referring to the drawings, several aspects of the present disclosure are shown in detail by way of not limitation but illustration:

FIG. 1 schematically shows a method for preparing an anode material for a lithium secondary battery according to the present disclosure.

FIG. 2 schematically shows an example of an electrospray method.

FIG. 3 shows a process of drying an encapsulated active material in a droplet form in an air-suspended chamber using an IR heater.

FIG. 4 schematically shows an example of applying IPL to an encapsulated active material in a powder form in an air-suspended chamber.

FIG. 5 schematically shows a charge and discharge process of an anode material for a lithium secondary battery according to the present disclosure.

FIG. 6 schematically shows an example of an apparatus for drying an encapsulated active material in a droplet form using a spray freeze-drying technique.

### MODE FOR THE INVENTION

The following descriptions and embodiments as described herein are provided as examples of the principles of the various forms of the present disclosure. These embodiments are provided for purposes of illustrative, non-limiting, descriptions of these principles in the present disclosure in various forms. The same reference numerals have been assigned to similar parts in the descriptions throughout the specifications and drawings. The drawings are not necessarily to scale, and in some cases, the scale may be exaggerated to more clearly depict a certain feature.

A method for preparing an anode material for a lithium secondary battery according to the present disclosure provides a method for preparing an anode material for a lithium secondary battery capable of minimizing negative side effects such as the volume change or high internal stress, destruction, crushing, peeling, electrical insulation from a conductive material, SEI instability and consequent consumption of electrolyte, and loss of energy capacity of the battery, of the anode of the lithium secondary battery such as a lithium ion battery, a lithium metal battery, a lithium air battery, a lithium sulfur battery, or a lithium all-solid-state battery.

Furthermore, a method for preparing an anode material for a lithium secondary battery according to the present disclosure may pre-lithiate and encapsulate an active material for an anode having a large volume expansion, such as silicon. To this end, the method of the present disclosure includes both drying the active material in the droplet form and applying photoelectromagnetic energy.

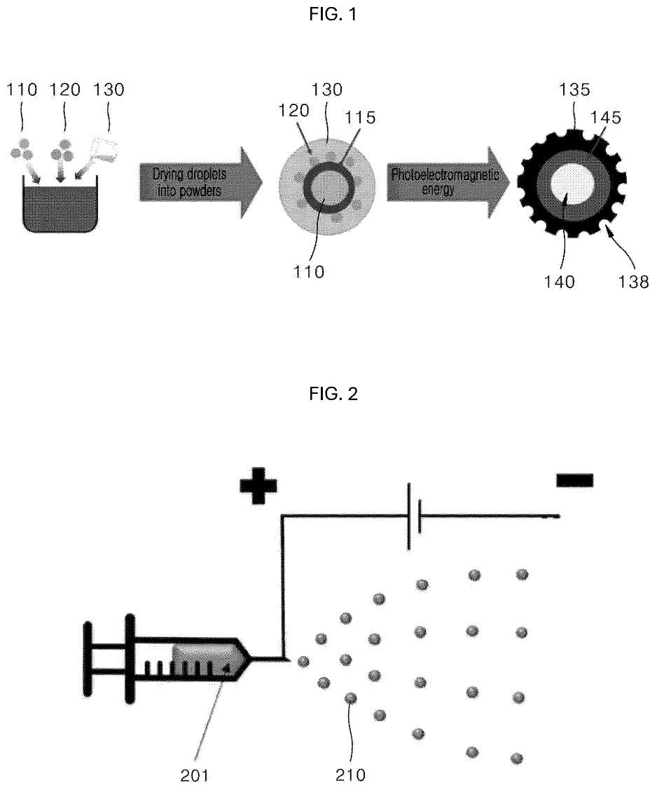

FIG. 1 schematically shows a method for preparing an anode material for a lithium secondary battery according to the present disclosure.

Referring to FIG. 1, the method for preparing an anode material for a lithium secondary battery according to the present disclosure includes a liquid mixture producing step, a droplet drying step, and a pre-lithiating and polymer carbonization step via application of photoelectromagnetic energy.

In the liquid mixture producing step, a liquid mixture is prepared by adding an active material 110, a lithium salt 120, and a polymer 130 into a solvent.

The liquid mixture used in the method for preparing an electrode for a lithium secondary battery according to the present disclosure includes the active material, the lithium salt, the polymer, and the solvent. In one example, based on 100 parts by weight of a solid content excluding the solvent in the liquid mixture, 80 to 95 parts by weight of the active material, 1 to 10 parts by weight of the lithium salt, and 1 to 10 parts by weight of the polymer may be contained. In this regard, the content of each of the active material, the lithium salt and the polymer may vary depending on a type of a material thereof. In one example, the solvent may be used in an appropriate amount depending on the type of the polymer as used. For example, 50 to 100 parts by weight of the solvent may be contained based on 100 parts by weight of the solid content.

The solvent may include an aqueous solvent (water, methanol, ethanol, etc.) and an organic solvent. Li₂O changes to LiOH in water, but remains as Li₂O and reacts in a methanol or ethanol solution. That is, Li2O has a reaction rate faster than that of LiOH. Silicon may be rapidly oxidized in the aqueous solvent. However, the organic solvent may prevent the portion of silicon from being rapidly oxidized to generate hydrogen gas.

The lithium salt may include at least one of Li₂O, LiOH, LiO₂CH, Li₂CO₃, Li₂C₂O₄, Li₃C₆H₅O₇, LiNO₃, LiCl, LiF, or a lithium functionalized polymer.

The active material may include at least one of silicon or silicon oxide.

The active material may be pre-surface-treated under application of photoelectromagnetic energy. Due to the pre-surface treatment, impurities contained in the active material may be burned in a short time, and a stable oxide layer may be formed on a surface of the active material, and a surface energy of the active material may be changed such that the wettability thereof to the electrolyte may be increased.

In one example, the lithium salt and the active material react with each other under the application of the photoelectromagnetic energy, and pores may be formed while the gas product from the reaction escapes to the outside. The formed pores allow the lithium ions to diffuse into the core active material.

The polymer may be used without limitations as long as the polymer may encapsulate the active material. For example, the polymer that may be used in the present disclosure may include at least one of polyacrylonitrile (PAN), polytetrafluoroethylene (PTFE), poly(methyl methacrylate) (PMMA), poly(3,4-ethylenedioxythiophene)polystyrene sulfonate (PEDOT:PSS), polydiacetylene (PDA), polypropylene (PP), polystyrene (PS), polyurethane (PU), polyethylene oxide (PEO), polyethylene terephthalate (PET), styrene-ethylene-butylene-styrene (SEBS), glycerol, sucrose, cellulose, lignin, polyvinylidene fluoride (PVDF), polyvinylidene fluoride trifluoroethylene (PVDF-TRFE), polyaniline, or parylene-C. However, the present disclosure is not limited thereto. When two or more types of polymers are included, the two or more types of polymers may include polymers having different boiling points, polymers which constitute a double network hydrogel such as a combination of carboxylmethylcellulose (CMC) and polyacrylic acid (PAA).

In another example, the polymer may include an organosilicon polymer containing an anode active material component therein, such as polysiloxane, polysilsequioxane, polycarbosiloxane, polyborosilane, or polysilicarbodiimide. The anode active material component contained in the polymer may provide additional energy capacity to the electrode and may provide an additional pre-lithiation source. A shell made of SiOC (silicon oxycarbide), SiC (silicon carbide), SiBCN (silicon boron carbonitride), SiCN (silicon carbonitride), etc. may be formed via carbonization of the organosilicon polymer containing the anode active material component therein.

In one example, the photoelectromagnetic energy may be applied in the step of producing the mixture. Thus, partial pre-lithiation of the active material and carbonization of the polymer may be achieved.

Furthermore, depending on the type of the lithium salt and the type of the polymer used for the encapsulation, reaction between the polymer and the lithium salt such as LiOH, LiCl, and LiF may occur. In this case, lithium ions may be converted to lithium metal which may remain in the polymer, and in turn react with the anode active material when energy is applied thereto. However, the reaction of the lithium metal with the anode active material may be slower than the reaction of the lithium salt with the anode active material. A larger amount of energy may be required in the reaction of the lithium metal with the anode active material.

In the droplet drying step, the liquid mixture may be sprayed using various spraying methods to form liquid droplets, and then the solvent may be removed therefrom by drying the liquid droplets. The droplet drying step may be carried out, for example, in an air-suspended chamber in which the liquid droplets may be dried into the powders while the liquid droplets are levitated and are circulating therein. The powder material obtained via the droplet drying step may be composed of the active material 110 and the polymer layer 130 surrounding the active material, as shown in FIG. 1. The lithium salt 120 may be included in the polymer layer 130. An oxide layer 115 may be formed on a surface of the active material 110.

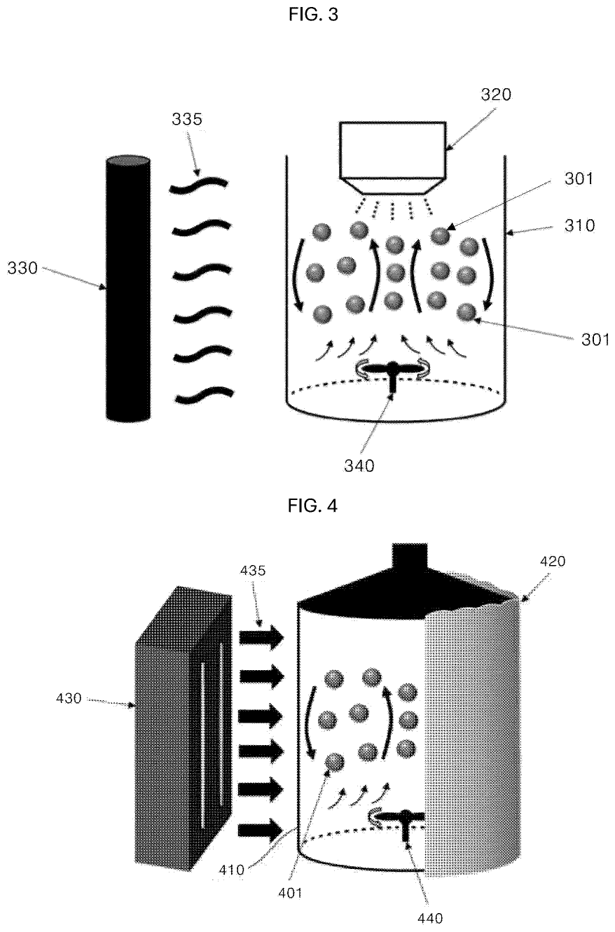

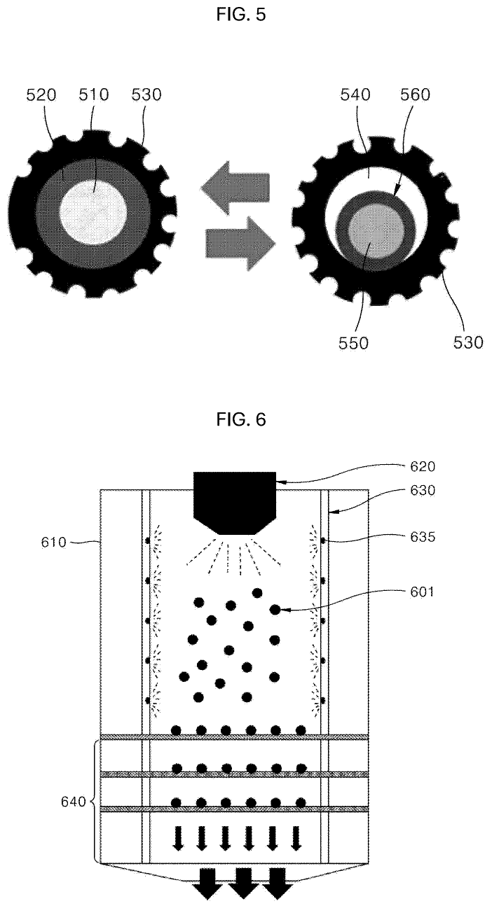

Specifically, the droplet drying step may include a step of spraying the liquid mixture into the air-suspended chamber using a scheme such as Collison nebulization, piezoelectric spray, ultrasonic spray, or electrospray to obtain the liquid droplets with a size of, for example, hundreds of nm to several um, and a step of drying the droplets while floating and circulating the liquid droplets in the air-suspended chamber using a heater as shown in FIG. 3 or of rapid-freezing the droplets using gaseous nitrogen and vacuum drying the frozen droplets as in the example shown in FIG. 6.

FIG. 2 schematically shows an example of the electrospray method.

In order to produce individually encapsulated active material powders, fine particles made of the mixture should be produced before the drying and the energy application.

FIG. 2 shows that the active material is sprayed in the form of the liquid droplets 210 while being encapsulated in a polymer binder via the electrospray using a Collison nebulizer 201 by way of example.

The Collison nebulizer was first developed by K. R. May in 1972, and has been recognized as an aerosolization technique of a variety of liquids for a long time. In the Collison nebulizer, air flows at high speed through a small orifice in the nebulizer, and then absorbs liquid from the nebulizer's jar and thus breaks into small liquid droplets. The sprayed liquid droplets then impinge on a wall of the jar, thereby generating smaller liquid droplets. Larger particles are removed from the aerosol by a curved discharge tube.

Unlike the example shown in FIG. 2, each of a piezoelectric atomizer and an ultrasonic sprayer uses a piezoelectric transducer to generate atomized particles. When a high-frequency voltage is applied to the transducer, high-frequency vibration is generated from the transducer. In the piezoelectric atomizer, the liquid is placed on the surface of the piezoelectric transducer, and vibrations are applied to the liquid via the transducer. The vibration generates capillary waves (standing waves) in the liquid, such that tiny liquid droplets are ejected from the liquid in the form of aerosols. In the ultrasonic spray, a sampling principle is applied because the liquid is sprayed when it reaches the surface of the vibrating nozzle. A size of each of the atomized particles depends on the applied vibration frequency. For the nanometer particle generation, vibrations at frequencies in the range of several megahertz (MHz) are required. Due to geometric constraints, the ultrasonic spray generally operates in the few megahertz range, and the operation frequency of the atomizer is limited to tens of kilohertz.

FIG. 3 shows the process of drying the encapsulated active material in the droplet form in an air-suspended chamber using an IR heater.

The droplet drying system as shown in FIG. 3 includes a transparent cylindrical chamber 310, an atom nozzle 320 for providing an encapsulated active material 301 in the form of a liquid drop as a drying target, an infrared heater 330 for applying heat 335 to the encapsulated active material, and a blower 340 for continuously levitating the encapsulated active material in the transparent cylindrical chamber 310.

In the droplet drying system as shown in FIG. 3, the encapsulated active material 301 sprayed through the atom nozzle 320 may be continuously floated and circulated in the air in the sealed transparent cylindrical chamber 310 by the blower 340. The heat from the infrared (IR) heater 330 may be irradiated thereto for drying.

In one example, as shown in FIG. 4, the photoelectromagnetic energy may be applied into the air-suspended chamber. Via this photoelectromagnetic energy application, the pre-lithiation of the active material and the polymer carbonization may be achieved. This photoelectromagnetic energy application may replace the photoelectromagnetic energy application step as described later, or may be separate from the photoelectromagnetic energy application step as described later.

In the pre-lithiation and polymer carbonization step via the application of the photoelectromagnetic energy, the photoelectromagnetic energy is applied to the powder obtained by drying the droplet to pre-lithiate the active material and at the same time, to carbonize at least a portion of the polymer surrounding the active material. Thus, when the active material is, for example, silicon, a lithium-silicon alloy 140, lithium silicate 145 as a lithium-silicon oxide, and a carbon film 135 having pores 138 defined therein may be obtained as shown in FIG. 1.

The photoelectromagnetic energy that may be used in the present disclosure may be applied in an intense pulsed light (IPL) or microwave form.

Among photoelectromagnetic energy applications, the IPL application is performed by irradiating high-power xenon-light. In this regard, the carbonization effect of the polymer may vary depending on the IPL application time. For example, when the IPL application time is within 5 milliseconds, the carbonization effect is mainly concentrated on the outer shell portion, resulting in a shell structure including a hard carbonized outer shell and a soft inner polymeric inner shell. For example, when the IPL application time exceeds 5 milliseconds, the entirety of the polymer may be carbonized, resulting in a shell made entirely of carbon.

Via the application of the photoelectromagnetic energy, the shell of the nanoporous structure results from the evaporation of the solvent and the polymer having a low-boiling point. The nanoporous structure facilitates lithium diffusion. The carbonized outer shell may provide structural rigidity. When the uncarbonized polymer inner shell is present, this inner shell may provide an elastic and deformable space for the volume change of the active material during the lithiation process.

The carbonized outer shell or the carbonized shell provides electrical conductivity along the solid electrolyte interface (SEI) and provides structural support. The inner soft polymer layer may be elastic, and thus provide an active material space for volume expansion while preventing the active material from being crushed.

In the microwave application, a partially or fully carbonized shell may be formed depending on the applied power or the application time.

In one example, after the step of applying the photoelectromagnetic energy, the anode material in the powder form may be further refined via a known milling method such as ball milling or jet milling.

The pre-lithiation of the anode active material such as silicon via the application of the photoelectromagnetic energy produces the lithiated active material particles such as LiₓSi and/or LiₓSiO_{y} based on a reaction between the active material and the lithium salt at a high temperature (e.g., equal to or higher than 200 °C).

In the method according to the present disclosure, the active material in the form of the powder may be pre-lithiated via reduction of lithium in a thermal reduction scheme by applying the photoelectromagnetic energy to the lithium salt. When a metal having a larger free energy change in the oxidation reaction than that of the lithium is used, the lithium is reduced while the metal is oxidized. For example, when a Si metal as the anode material is used as a reducing agent, the lithium salt such as lithium oxide is reduced to the lithium metal via the application of the photoelectromagnetic energy such as IPL, such that the pre-lithiated Si particles such as a lithium-silicon alloy (LiₓSi) and/or lithium silicate (LiₓSiO_{y}) may be produced.

FIG. 4 schematically shows an example of applying the IPL to the encapsulated active material in the powder form in the air-suspended chamber.

The IPL application may be considered as the energy application scheme more applicable to the encapsulated active material in the powder form because the IPL may be irradiated onto a larger surface area at once. Further, a typical IPL system may emit light in a 200 to 1100 nm spectrum with a pulse duration of a few milliseconds and an energy density of 12 J/cm². For the general IPL system, a diffusion depth of the IPL irradiation is limited to about 1 μm from a surface. Thus, the general IPL system is more suitable for treating the powdery active materials.

Referring to FIG. 4, in a chamber 410 specially designed to evenly irradiate the encapsulated active material powder 401 with the energy of the intense pulsed light (IPL) 435, the dried encapsulated active material powder 401 is floated in the air using a blower 440. The chamber 410 is made of a light-transmitting material (such as glass or transparent polycarbonate). The blower 440 floats the encapsulated active material 401 in the air via continuous blowing. An IPL lamp 430 is embodied as a xenon lamp and is disposed to face the chamber 410. The other side of the chamber 410 opposite to one side thereof to which the IPL is irradiated is covered with a reflector 420 to irradiate the IPL to all sides of the active material particles in the IPL application process.

As shown in FIG. 1, an anode material for a lithium secondary battery according to an embodiment of the present disclosure may be a powder including the lithiated active material and the shell layer surrounding the lithiated active material, wherein the pores are formed in the shell layer. The lithiated active material includes the lithium-silicon alloy and the lithium silicate layer surrounding the lithium-silicon alloy. The outermost portion of the shell layer may be made of carbon.

The shell layer having at least the outermost portion made of carbon may include 1D or 2D type carbonaceous material such as carbon nanotube and/or graphene oxide to enhance absorption of energy from the electromagnetic wave in a wide wavelength range, and to improve the electrical conductivity of the resulting anode material.

In a lithium secondary battery, a first charging process is very important for battery performance. During the first charging process, the organic electrolyte may be reduced to form a solid electrolyte interface on a surface of the anode. During a first lithiation process, some lithium ions may be trapped in the electrode. This may lead to irreversible loss of the net energy capacity of the battery. A first cycle is particularly important when silicon which undergoes large volume change during the charging and discharging process is used as the material of the anode.

In accordance with the present disclosure, the loss of energy density in the first charge cycle may be compensated for by the pre-lithiation of the active material in the same way as described above.

FIG. 5 schematically shows a charge and discharge process of an anode material for a lithium secondary battery according to the present disclosure.

The silicon or silicon oxide anode active material may be pre-lithiated to produce a lithium-silicon alloy 510. A lithium silicate layer 520 may be formed on the surface of the lithium-silicon alloy 510. A carbon layer 530 having a plurality of pores defined therein may be formed on a surface of the lithium silicate layer 520. Via the pre-lithiation of the anode active material, during the discharge process, a lithium component escapes from the anode from beginning of a battery operation to produce a silicon core 550 and a silicon oxide layer 560 surrounding the silicon core, and to form a space 540 between the silicon oxide layer and the carbon layer. During the charging process, the lithium component may flow into the anode. This charge/discharge process may be facilitated by the large number of pores defined in the surface of the anode material. In accordance with the present disclosure, the shell made of hard carbon surrounds the active material so as to fit the volume of the active material that is lithiated and thus expanded, that is, so as to maintain the space 540 during the discharge process. Thus, a structure of the anode active material may not be broken, which may otherwise occur due to the volume change of silicon during the subsequent charging and discharging process.

FIG. 6 schematically shows an example of an apparatus for drying the encapsulated active material in a droplet form using spray freeze-drying technique.

The spray freeze-drying system as shown in FIG. 6 includes a transparent cylindrical chamber 610, an atom nozzle 620 for providing an encapsulated active material 601 in a form of a droplet, a nitrogen gas atomizing device 630 having nozzles 635 for freezing the encapsulated active material 601, and a vacuum unit 640 having a filter mesh and a vacuum pump for continuously drying the encapsulated active material in the transparent cylindrical chamber 610.

Using the apparatus as shown in FIG. 6, the liquid mixture is sprayed into the chamber to produce the liquid droplets, and the liquid droplets are quickly frozen using nitrogen gas to produce the frozen droplets, and the frozen droplets may be vacuum dried into the powders.

The encapsulated active material powder obtained via the freeze-drying as shown in FIG. 6 may then be carbonized via the IPL or microwave irradiation in the air-suspended chamber as shown in FIG. 4.

In the above descriptions, the embodiment of the present disclosure has been mainly described, but various changes or modifications may be made at the level of a person skilled in the art. Accordingly, it may be understood that such changes and modifications are included within the scope of the present disclosure as long as they do not deviate from the scope of the present disclosure.

1. A method for preparing an anode material for a lithium secondary battery, the method comprising:
mixing an active material, a polymer and a lithium salt with each other in a solvent to produce a liquid mixture;
converting the liquid mixture into liquid droplets and drying the droplets into powders; and
applying photoelectromagnetic energy to the powders to pre-lithiate the active material and to carbonize at least a portion of the polymer.

2. The method of claim 1, wherein the active material includes at least one of silicon or silicon oxide.

3. The method of claim 1, wherein the active material is pre-surface-treated under the application of the photoelectromagnetic energy.

4. The method of claim 1, wherein the lithium salt and the active material react with each other under the photoelectromagnetic energy application, and a gas product from the reaction escapes to an outside to generate pores.

5. The method of claim 1, wherein the lithium salt includes at least one of Li₂O, LiOH, LiO₂CH, Li₂CO₃, Li₂C₂O₄, Li₃C₆H₅O₇, LiNO₃, LiCl, LiF or a lithium functionalized polymer.

6. The method of claim 1, wherein the solvent includes an aqueous or organic solvent.

7. The method of claim 1, wherein converting the liquid mixture into the liquid droplets and drying the droplets into the powders includes:
spraying the liquid mixture into an air-suspended chamber to produce the liquid droplets; and
drying the liquid droplets into the powders using a heater while the liquid droplets are floated and circulated in the air-suspended chamber.

8. The method of claim 7, wherein applying the photoelectromagnetic energy includes applying the photoelectromagnetic energy into the air-suspended chamber.

9. The method of claim 1, wherein converting the liquid mixture into the liquid droplets and drying the droplets into the powders includes:
spraying the liquid mixture into a chamber to produce the liquid droplets;
rapidly-freezing the liquid droplets in the chamber using nitrogen gas to produce frozen droplets; and
vacuum-drying the frozen droplets into the powders.

10. An anode material for a lithium secondary battery, the anode material comprising:
a lithiated active material; and
a shell layer surrounding the lithiated active material and having pores formed therein,
wherein the lithiated active material includes a lithium-silicon alloy and a lithium silicate layer surrounding the lithium-silicon alloy,
wherein an outermost portion of the shell layer is made of carbon.

11. The anode material of claim 10, wherein an entirety of the shell layer is made of carbon.

12. The anode material of claim 10, wherein the shell layer includes an outer shell made of carbon, and an inner shell made of the polymer.
